(19) United States
(12) Patent Application Publication
(10) Pub. No.: US 2026/0094916 A1
(43) Pub. Date: Apr. 2, 2026

(54) BOLTED BUSBAR AND BATTERY PACK

(71) Applicants: FARASIS ENERGY (GANZHOU) CO., LTD., Ganzhou (CN); FARASIS ENERGY (ZHENJIANG) CO., LTD., Zhenjiang (CN)

(72) Inventors: Weiran JIANG, Ganzhou (CN); Jianwei CHEN, Ganzhou (CN); Liang FENG, Ganzhou (CN); Yonghui ZHU, Ganzhou (CN); Yiqi HUANG, Ganzhou (CN)

(73) Assignees: FARASIS ENERGY (GANZHOU) CO., LTD., Ganzhou, JX (CN); FARASIS ENERGY (ZHENJIANG) CO., LTD., Zhenjiang, JS (CN)

(21) Appl. No.: 18/964,633

(22) Filed: Dec. 1, 2024

(30) Foreign Application Priority Data
Sep. 27, 2024 (CN) 202422364835.7

(51) Int. Cl. H01M 50/262; H01M 50/503; H01M 50/507; H01M 50/514; H01M 50/524; H01M 50/552

(52) U.S. Cl. CPC H01M 50/262; H01M 50/503; H01M 50/507; H01M 50/514; H01M 50/524; H01M 50/552

(57) ABSTRACT

Disclosed are a bolted busbar and a battery packing comprising the bolted busbar. The bolted busbar comprises a post assembly, a first busbar board and a second busbar board, wherein the post assembly comprises a connecting block and a plastic wrapper wrapping around the connecting block, the first busbar board and the second busbar board are respectively fixed to two sides of the connecting block, and cell connecting portions are arranged on the first busbar board and the second busbar board and connected to post terminals of cells. The bolted busbar is not provided with a receding structure, thus being simple in structure and easy to install.

### BACKGROUND OF THE INVENTION

### 1. Technical Field

The disclosure belongs to the technical field of batteries, and particularly relates to a bolted busbar and a battery pack using the bolted busbar.

### 2. Description of Related Art

The main energy body of a battery pack is formed by multiple modules that are electrically connected in series or in parallel by means of busbars. To ensure the structural stability of the battery pack, horizontal and longitudinal support beams are often arranged between the modules, and receding structures corresponding to the horizontal and longitudinal support beams need to be arranged on the busbars accordingly, leading to a complex structure of the busbars, a large space occupied by the busbars, and a complex assembly process.

### BRIEF SUMMARY OF THE INVENTION

The technical issue to be settled by the disclosure is to overcome the abovementioned defects in the prior art by providing a bolted busbar and a battery pack comprising the bolted busbar. The bolted busbar does not need to be provided with a receding structure, thus being simple in structure and easy to install.

To settle the above technical issue, the disclosure adopts the following technical solution:

A bolted busbar comprises a post assembly, a first busbar board and a second busbar board, wherein the post assembly comprises a connecting block and a plastic wrapper wrapping around the connecting block, the first busbar board and the second busbar board are respectively fixed to two sides of the connecting block, and cell connecting portions are arranged on the first busbar board and the second busbar board and connected to post terminals of cells.

Preferably, multiple fasteners are arranged on two sides of the plastic wrapper and connected to a support beam in a box of a battery pack.

Preferably, the fasteners are buckle fasteners.

Preferably, two fasteners are arranged on each of the two sides of the plastic wrapper, and the fasteners on the two sides of the plastic wrapper are symmetric with respect to a vertical center line of the plastic wrapper.

Preferably, the cell connecting portions are tapered arch structures, a cross-section of the cell connecting portions is arc-shaped, and an opening is formed in a side, away from the first busbar board or the second busbar board, of each cell connecting portion.

Preferably, the plastic wrapper warps around four sides of the connecting block, and the first busbar board and the second busbar board are mounted on two end surfaces of the connecting block.

Preferably, a fixing assembly comprises a bolt and a nut, a first through-hole is formed in the connecting block, a second through-hole and a third through-hole are respectively formed in the first busbar board and the second busbar board, and the bolt penetrates through the second through-hole, the first through-hole and the third through-hole to be connected to the nut to fix the first busbar board and the second busbar board to the connecting block.

Preferably, two fixing assemblies are arranged in a length direction of the connecting block.

Preferably, the fixing assembly further comprises gaskets, and the gaskets are arranged between the bolt and the first busbar board as well as between the nut and the second busbar board.

The disclosure further provides a battery pack, comprising a box, a support beam arranged in the box, cells arranged on two sides of the support beam, and the bolted busbar, wherein mounting holes and fixing holes are formed in the support beam, the fixing holes are located on two sides of the mounting holes, and the number of the fixing holes is the same as the number of the fasteners; the connecting block and the plastic wrapper are mounted in the mounting holes, and the fasteners of the plastic wrapper are respectively engaged in the fixing holes; and the first busbar board and the second busbar board stretch out from the mounting holes of the support beam respectively, and post terminals of the cells on the two sides of the support beam are respectively inserted into the cell connecting portions on the first busbar board and the second busbar board.

The bolted busbar provided by the disclosure can directly penetrate through mounting holes in the support beam in the box to connect the cells on two the sides of the support beam, thus being free of a receding structure, simple in structure and easy to install and occupying a small space. The problem that existing busbars between modules in a battery pack are complex in structure and occupy a large space is solved, and the part assembly convenience and space utilization of the whole battery pack are improved.

### BRIEF DESCRIPTION OF THE SEVERAL VIEWS OF THE DRAWINGS

FIG. 1 is a perspective structural view of a bolted busbar in Embodiment 1 of the disclosure;

FIG. 2 is a partial structural view of the bolted busbar in Embodiment 1 of the disclosure;

FIG. 3 is a top view of the bolted busbar in Embodiment 1 of the disclosure;

FIG. 4 is a first sectional view of a joint between a bolted busbar and a support beam along a vertical central plane of a connecting block in Embodiment 2 of the disclosure;

FIG. 5 is a front view of a battery pack in Embodiment 2 of the disclosure;

FIG. 6 is a second sectional view of the joint between the bolted busbar and the support beam along the center of a fastener in Embodiment 2 of the disclosure;

FIG. 7 is a structural view of mounting holes and fixing holes of the support beam in Embodiment 2 of the disclosure.

In the FIGS.: 100, bolted busbar; 110, first busbar board; 120, second busbar board; 130, connecting block; 140, plastic wrapper; 141, fastener; 150, cell connecting portion; 160, support beam; 161, mounting hole; 162, fixing hole; 170, bolt; 171, nut; 172, gasket; 200, box; 210, cell.

### DETAILED DESCRIPTION OF THE INVENTION

The technical solutions of the disclosure will be clearly and completely described below in conjunction with the accompanying drawings of the disclosure. Obviously, the embodiments in the following description are merely illustrative ones, and are not all possible ones of the disclosure. All other embodiments obtained by those ordinarily skilled in the art based on the following ones without creative labor should also fall within the protection scope of the disclosure.

In the description of the disclosure, it should be noted that terms such as “upper” are used to indicate directional or positional relations based on the accompanying drawings merely for the purpose of facilitating and simplifying the description, do not indicate or imply that devices or elements referred to must be in a specific direction or be configured and operated in a specific direction, and thus should not be construed as limitations of the disclosure.

In the description of the disclosure, terms “first” and “second” are merely used for the purpose of description and should not be construed as indicating or implying relative importance.

In the description of the disclosure, it should be noted that terms such as “connect”, “arrange”, “install” and “fix” should be broadly understood, unless otherwise expressly stated and defined. For example, “connect” may refer to fixed connection, detachable connection or integrated connection; or, direct connection, indirect connection by means of an intermediate medium, or internal connection of two elements. Those skilled in the art can appreciate the specific meanings of these terms in the disclosure as the case may be.

The disclosure provides a bolted busbar, comprising a post assembly, a first busbar board and a second busbar board, wherein the post assembly comprises a connecting block and a plastic wrapper wrapping around the connecting block, the first busbar board and the second busbar board are respectively fixed to two sides of the connecting block, and cell connecting portions are arranged on the first busbar board and the second busbar board and connected to post terminals of cells.

The disclosure further provides a battery pack, comprising a box, a support beam arranged in the box, cells arranged on two sides of the support beam, and the bolted busbar described above, wherein mounting holes and fixing holes are formed in the support beam, the fixing holes are located on two sides of the mounting holes, the number of the fixing holes is the same as the number of fasteners, the connecting block and the plastic wrapper are mounted in the mounting holes, multiple fasteners of the plastic wrapper are respectively engaged in the multiple fixing holes, the first busbar board and the second busbar board stretch out from the mounting holes of the support beam respectively, and post terminals of the cells on the two sides of the support beam are respectively inserted into the cell connecting portions on the first busbar board and the second busbar board.

### Embodiment 1

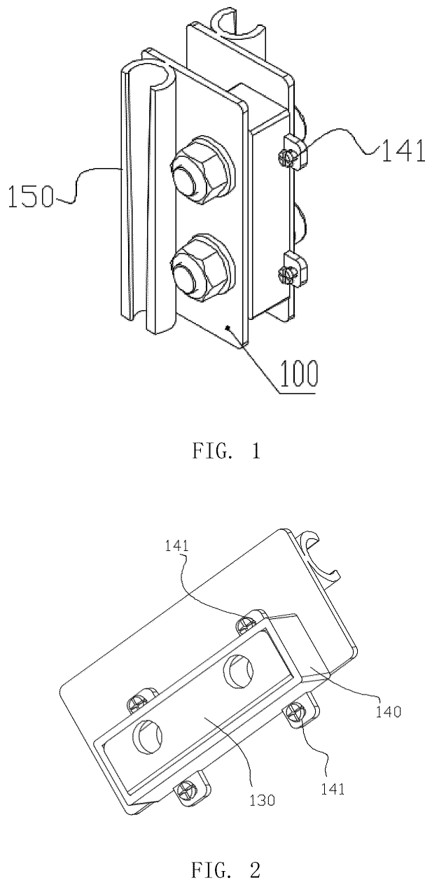

As shown in FIGS. 1-3, this embodiment discloses a bolted busbar 100, comprising a post assembly, a first busbar board 110 and a second busbar board 120. The post assembly comprises a connecting block 130 and a plastic wrapper 140 wrapping around the connecting block 130, the connecting block 130 is made from a metal material, the first busbar board 110 and the second busbar board 120 are fixed to two sides of the connecting block 130 respectively, and cell connecting portions 150 are arranged on the first busbar board 110 and the second busbar board 120 and connected to post terminals of cells 210.

In this embodiment, multiple fasteners are arranged on two sides of the plastic wrapper 140 and connected to a support beam 160 in a box 200 of a battery pack. Specifically, the fasteners are buckle fasteners.

Specifically, two fasteners are arranged on each of the two sides of the plastic wrapper 140, and the fasteners on the two sides of the plastic wrapper 140 are symmetric with respect to a vertical center line of the plastic wrapper 140. Four fasteners are arranged on the two sides of the plastic wrapper 140 in total, and the two fasteners on one side of the plastic wrapper 140 are respectively arranged at an upper end and a lower end of the plastic wrapper 140 and are symmetric with the two fasteners on the other side of the plastic wrapper 140.

As shown in FIG. 1, the cell connecting portions 150 are tapered arch structures and arranged in a length direction of the first busbar board 110 and the second busbar board 120, a cross-section of the cell connecting portions 150 is arc-shaped, and an opening is formed in a side, away from the first busbar board 110 or the second busbar board 120, of each cell connecting portion 150. The cell connecting portions 150 are matched with tapered post terminals of the cells 210, and the tapered post terminals of the cells 210 are in plug-in connection with the cell connecting portions 150.

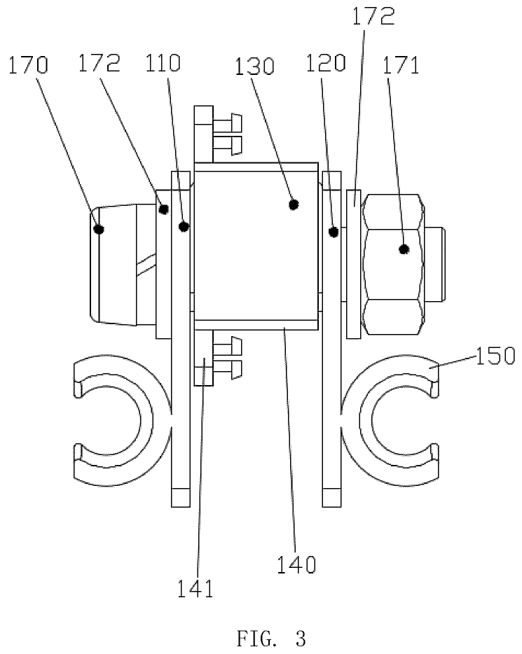

As shown in FIGS. 2 and 3, the plastic wrapper 140 wraps around four sides of the connecting block 130, and the first busbar board 110 and the second busbar board 120 are mounted on two end surfaces of the connecting block 130, thus ensuring that the first busbar board 110 and the second busbar board 120 are electrically connected to the connecting block 130.

As shown in FIGS. 1 and 3, a fixing assembly comprises a bolt 170 and a nut 171, a first through-hole is formed in the connecting block 130, and a second through-hole and a third through-hole are respectively formed in the first busbar board 110 and the second busbar board 120. When the bolted busbar is assembled, the first through-hole, the second through-hole and the third through-hole are aligned, then the bolt 170 sequentially penetrates through the second through-hole, the first through-hole and the third through-hole to be connected to the nut 171 to fix the first busbar board 110 and the second busbar board 120 to the connecting block 130.

As shown in FIG. 3, the fixing assembly further comprises gaskets 172, and the gaskets 172 are arranged between the bolt 170 and the first busbar board 110 as well as between the nut 171 and the second busbar board 120.

As shown in FIG. 1, two fixing assemblies are arranged in a length direction of the connecting block 130 in a spaced manner. Specifically, two first through-holes are formed in the connecting block 130, two second through-holes and two third through-holes are respectively formed in the first busbar board 110 and the second busbar board 120, and correspondingly, two bolts 170, two nuts 171 and two gaskets 172 are arranged.

The bolted busbar 100 in this embodiment can directly penetrate through mounting holes 161 in the support beam 160 in the box 200 to connect the cells 210 on two sides of the support beam 160, thus being free of a receding structure, simple in structure and easy to install and occupying a small space. The problem that existing busbars between modules in a battery pack are complex in structure and occupy a large space is solved, and the part assembly convenience and space utilization of a whole battery pack are improved.

### Embodiment 2

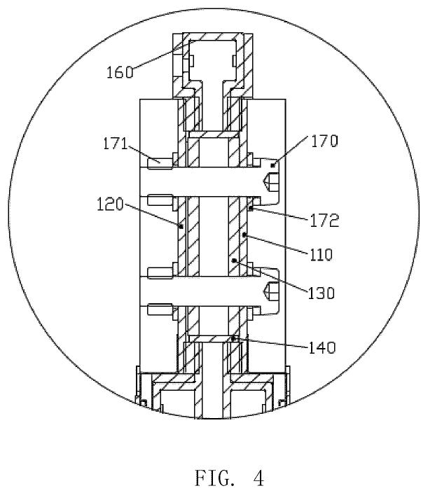

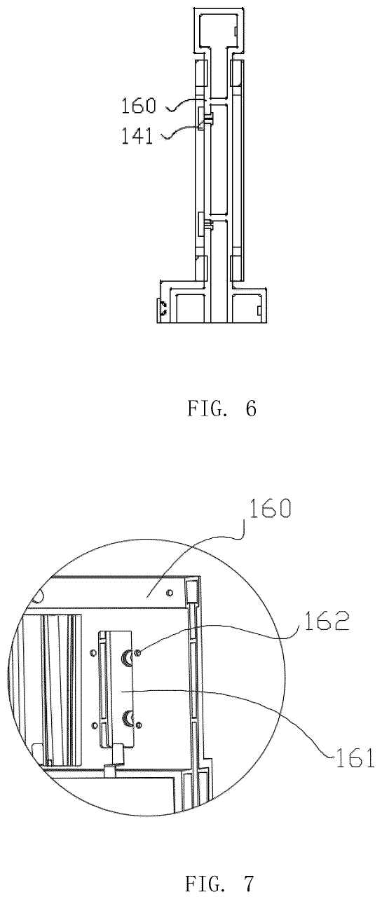

As shown in FIGS. 4-7, this embodiment discloses a battery pack, comprising a box 200, a support beam 160 arranged in the box 200, cells 210 arranged on two sides of the support beam 160, and the bolted busbar 100 in Embodiment 1.

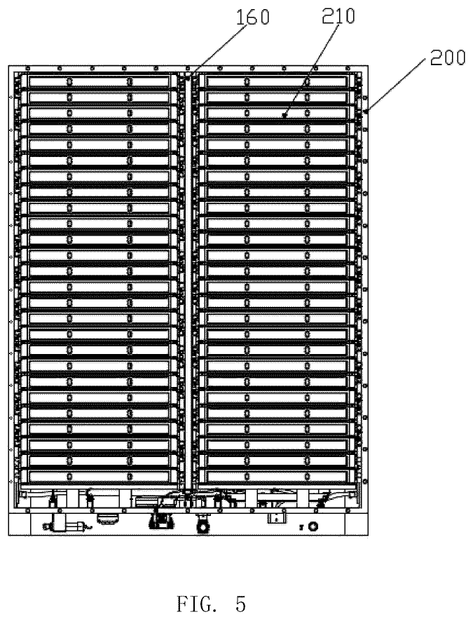

As shown in FIG. 5, in this embodiment, the support beam 160 is a longitudinal beam which is arranged longitudinally and divides the box 200 into a left area and a right area, and the cells 210 are placed in the left area and the right area respectively.

As shown in FIGS. 4, 6 and 7, the support beam 160 has an I-shaped cross-section in a vertical direction and is hollowed out, mounting holes 161 of a same size are formed in side walls of two sides of the support beam 160 respectively and are aligned in position, the size of the mounting holes 161 matches the size of the connecting block 130 and the size of the plastic wrapper 140, the connecting block 130 and the plastic wrapper 140 are mounted in the mounting holes 161, fixing holes 162 are formed in the side wall of one side of the support beam 160, the number of the fixing holes 161 is the same as the number of the fasteners and is four, the four fixing holes 162 are located on two sides of the mounting holes 161 (two four fixing holes 162 on each side), and the mounting holes 161 in the two sides of the support beam 160 are symmetric.

The four fasteners on the plastic wrapper 140 are respectively engaged in the four fixing holes 162 in the side wall of one side of the support beam 160 to be connected to the support beam 160, the first busbar board 110 and the second busbar board 120 stretch out from the mounting holes 161 in the side walls of the two sides of the support beam 160 respectively to be located on the two sides of the support beam 160, and post terminals of the cells 210 on the two sides of the support beam 160 are respectively inserted into the cell connecting portions 150 on the first busbar board 110 and the second busbar board 120, such that the cells 210 on the two sides of the support beam 160 are connected.

As shown in FIGS. 2, 6 and 7, specifically, the fastener comprises four petal structures that can be closed and opened. Before the fastener is inserted into the fixing hole 162 in the support beam 160, the four pedal structures are closed to pass through the fixing hole 162 and are then opened, such that the fastener is firmly clamped on the support beam 160.

The structure of the support beam 160 in the battery pack in this embodiment matches the structure of the bolted busbar 100, such that the bolted busbar 100 can directly penetrate through the mounting hole 161 in the support beam 160 in the box 200 to connect the cells 210 on the two sides of the support beam 160, and a receding structure does not need to be arranged on the bolted busbar 100, thus simplifying the structure of the bolted busbar 100, reducing the space occupied by the bolted busbar 100, and improving the installation efficiency of the battery pack, and the part assembly efficiency and space utilization the whole battery pack.

It can be understood that the above embodiments are merely illustrative ones used for explaining the principle of the disclosure, and the disclosure is not limited to the above embodiments. For those ordinarily skilled in the art, various transformations and improvements can be made without departing from the spirit and essence of the disclosure, and all these transformations and improvement should also fall within the protection scope of the disclosure.

What is claimed is:

1. A bolted busbar, comprising a post assembly, a first busbar board (110) and a second busbar board (120);
wherein the post assembly comprises a connecting block (130) and a plastic wrapper (140) wrapping around the connecting block (130), the first busbar board (110) and the second busbar board (120) are respectively fixed to two sides of the connecting block (130), and cell connecting portions (150) are arranged on the first busbar board (110) and the second busbar board (120) and connected to post terminals of cells (210).

2. The bolted busbar according to claim 1, wherein multiple fasteners are arranged on two sides of the plastic wrapper (140) and connected to a support beam (160) in a box (200) of a battery pack.

3. The bolted busbar according to claim 2, wherein the fasteners are buckle fasteners.

4. The bolted busbar according to claim 3, wherein two said fasteners are arranged on each of the two sides of the plastic wrapper (140), and the fasteners on the two sides of the plastic wrapper (140) are symmetric with respect to a vertical center line of the plastic wrapper (140).

5. The bolted busbar according to claim 1, wherein the cell connecting portions (150) are tapered arch structures, a cross-section of the cell connecting portions (150) is arc-shaped, and an opening is formed in a side, away from the first busbar board (110) or the second busbar board (120), of each said cell connecting portion (150).

6. The bolted busbar according to claim 1, wherein the plastic wrapper (140) warps around four sides of the connecting block (130), and the first busbar board (110) and the second busbar board (120) are mounted on two end surfaces of the connecting block (130).

7. The bolted busbar according to claim 1, wherein a fixing assembly comprises a bolt (170) and a nut (171), a first through-hole is formed in the connecting block (130), a second through-hole and a third through-hole are respectively formed in the first busbar board (110) and the second busbar board (120), and the bolt (170) penetrates through the second through-hole, the first through-hole and the third through-hole to be connected to the nut (171) to fix the first busbar board (110) and the second busbar board (120) to the connecting block (130).

8. The bolted busbar according to claim 7, wherein two said fixing assemblies are arranged in a length direction of the connecting block (130).

9. The bolted busbar according to claim 7, wherein the fixing assembly further comprises gaskets (172), and the gaskets (172) are arranged between the bolt (170) and the first busbar board (110) as well as between the nut (171) and the second busbar board (120).

10. A battery pack, comprising a box (200), a support beam (160) arranged in the box (200), and cells (210) arranged on two sides of the support beam (160), wherein the battery pack further comprises the bolted busbar (100) according to claim 2;
mounting holes (161) and fixing holes (162) are formed in the support beam (160), the fixing holes (162) are located on two sides of the mounting holes (161), and the number of the fixing holes (162) is the same as the number of the fasteners;
the connecting block (130) and the plastic wrapper (140) are mounted in the mounting holes (161), and the fasteners of the plastic wrapper (140) are respectively engaged in the fixing holes (162);
the first busbar board (110) and the second busbar board (120) stretch out from the mounting holes (161) of the support beam (160) respectively, and post terminals of the cells (210) on the two sides of the support beam (160) are respectively inserted into the cell connecting portions (150) on the first busbar board (110) and the second busbar board (120).
